(19) United States
(12) Patent Application Publication
(10) Pub. No.: US 2016/0162968 A1
(43) Pub. Date: Jun. 9, 2016

(54) METHOD OF ALLOWING SELECTION OF FINE JEWELRY FOR POSSIBLE PRUCHASE BY PRIOR EXAMINATION OF REPLICA JEWELRY

(71) Applicant: Diamonds Direct USA, Inc., Charlotte, NC (US)

(72) Inventors: Amit Eldar, Charlotte, NC (US); ltay Berger, Charlotte, NC (US)

(21) Appl. No.: 14/946,209

(22) Filed: Nov. 19, 2015

Related U.S. Application Data
(63) Continuation of application No. 14/791,998, filed on Jul. 6, 2015.
(60) Provisional application No. 62/089,387, filed on Dec. 9, 2014.

(51) Int. Cl. G06Q 30/06; G06Q 20/12; G06Q 30/00; G06Q 10/08

(52) U.S. Cl. CPC G06Q 30/0623; G06Q 10/087; G06Q 10/083; G06Q 20/12; G06Q 30/0185

(57) ABSTRACT

A method of providing a home shopping experience that includes activities that are usually only available when shopping in a retail store environment, that includes the steps of selecting genuine jewelry items to replicate as inexpensive samples, replicating the genuine jewelry items, and indicating on a selected website that samples of selected genuine jewelry items are available for shipment to a customer address for examination. Upon selection of samples by the customer via the website, the selected samples are shipped to the address specified by the customer. Upon a customer decision to purchase the genuine jewelry item, the genuine jewelry item is shipped to the customer and the customer is charged for the jewelry item.

### CROSS REFERENCE TO RELATED PATENT APPLICATIONS

This application is a continuation which claims priority to and benefit from U.S. patent application Ser. No. 14/791,998, filed on Jul. 6, 2015, and U.S. Provisional Application No. 62/089,387, filed on Dec. 9, 2014, the entire contents of which are expressly incorporated herein by reference.

### TECHNICAL FIELD AND BACKGROUND OF THE INVENTION

This application relates to and discloses a method of providing a home shopping experience that includes activities that are usually only available when shopping in a retail store environment. More specifically, the application discloses a method of marketing jewelry products by permitting the potential purchaser to actually examine, wear and obtain purchase opinions or confirmations of the desirability of purchasing the jewelry items based on selections made over the internet, and without visiting a retail store.

Jewelry items vary in price substantially based on the quality of craftsmanship, and the cost, rarity and quality of stones set into the item. High quality, “fine” or “designer” jewelry is typically fabricated of metals such as gold, platinum and silver, and alloys of these metals. Similarly, high quality jewelry is set with precious and semiprecious stones such as diamonds, emeralds and sapphires, and exhibits skilled, high quality craftsmanship.

Less expensive jewelry is typically fabricated of inexpensive metals or metal alloys, and set with either low quality genuine gems or artificial replicas such as diamond simulants. These inexpensive items, often referred to as “costume” or “fashion” jewelry, have been sold over the internet for many years, and are paid for at the time of order, typically by credit card. Of course, expensive jewelry is also sold over the internet, but the requirement that it be paid for at the time of purchase is a deterrent to many purchasers, who may be reluctant to make an expensive purchase from a seller at a remote location without the ability to examine the jewelry piece carefully, and wear the jewelry piece to judge the desirability of actually making the purchase. For this reason, expensive, fine jewelry is usually sold in retail jewelry stores, or in fine jewelry departments of department stores, where the prospective purchaser can carefully examine, wear and compare several pieces before making a purchase decision.

Therefore, there is a need for a method of shopping for jewelry that enables an educated purchase decision to be made via the internet by allowing a prospective customer to evaluate a replica of a fine jewelry item before making a purchase decision.

### SUMMARY OF THE INVENTION

It is therefore an object of the invention to provide a method of allowing a prospective purchaser to examine replicas of fine jewelry items at home based on a selection made over the internet.

It is another object of the invention to provide a method of allowing a prospective purchaser to examine replicas of fine jewelry items at home as a basis for making a decision to purchase the genuine fine jewelry item.

These and other objects and advantages of the present invention are achieved in the preferred embodiment disclosed below by providing a method of providing a home shopping experience to a prospective purchaser that replicates activities available when shopping in a retail store environment, that includes the steps of selecting by a prospective seller of genuine jewelry items to replicate as inexpensive samples and replicating the genuine jewelry items in the form of inexpensive samples. A selected publication is provided where replica samples of selected genuine jewelry items are available for shipment to a customer address for examination. Upon selection by the customer of one or more samples in the selected publication of the prospective seller and communication of the selection to the prospective seller, the selected samples are shipped to the address specified by the customer. Upon a customer decision to purchase the genuine jewelry item, the genuine jewelry item is shipped to the customer and charging the customer for the genuine jewelry item.

According to one preferred embodiment of the invention, the selected publication is posted on a website of the prospective seller.

According to another preferred embodiment of the invention, the method includes the step of securing funds to cover the cost of the replica sample jewelry items if they are not returned by the prospective purchaser.

According to another preferred embodiment of the invention, the replica jewelry item is permanently and visibly marked with information indicating the name of the prospective seller.

According to another preferred embodiment of the invention, the information includes a visible indication that the replica jewelry item is not a genuine article of fine jewelry.

According to another preferred embodiment of the invention, the replica jewelry item is shipped to the prospective customer with a prepaid label for returning the replica jewelry item.

According to another preferred embodiment of the invention, the method includes the steps of custom-creating a replica jewelry item of a genuine fine jewelry item at the request of a prospective customer, and maintaining an inventory of replica jewelry items to match a selection of fine jewelry items desired to be sold in accordance with the method.

According to another preferred embodiment of the invention, a home shopping experience is provided that includes activities that are usually only available when shopping in a retail store environment, that includes the steps of selecting by a prospective seller of genuine jewelry items to replicate as inexpensive samples and replicating the genuine jewelry items in the form of inexpensive sample jewelry items. On a selected website, the prospective seller indicates that samples of selected genuine jewelry items are available for shipment to a customer address for examination. Upon selection of samples by the customer via the website, the selected samples are shipped to the address specified by the customer. Upon a customer decision to purchase the genuine jewelry item, the genuine jewelry item is shipped to the customer and the customer is charged for the jewelry item.

According to another preferred embodiment of the invention, the method includes the step of securing funds to cover the cost of the replica sample jewelry items if they are not returned by the prospective purchaser.

According to another preferred embodiment of the invention, the replica jewelry item is permanently and visibly marked with information indicating the name of the prospective seller.

According to another preferred embodiment of the invention, the information includes a visible indication that the replica jewelry item is not a genuine article of fine jewelry.

According to another preferred embodiment of the invention, the replica jewelry item is shipped to the prospective customer with a prepaid label for returning the replica jewelry item.

According to another preferred embodiment of the invention, the method includes the steps of custom-creating a replica jewelry item of a genuine fine jewelry item at the request of a prospective customer, and maintaining an inventory of replica jewelry items to match a selection of fine jewelry items desired to be sold in accordance with the method.

According to another preferred embodiment of the invention, the prospective purchaser is prompted to create an on-line account for processing any transactions.

According to another preferred embodiment of the invention, the prospective customer is advised on the internet site that the replica jewelry item is visibly indicated as being a replica jewelry item and not a genuine article of fine jewelry.

According to another preferred embodiment of the invention, the internet site includes a programmable general purpose computer for carrying out the functions of the website.

According to another preferred embodiment of the invention, the computer is programmed to impose a limited amount of time for a prospective customer to make a purchase decision, and if the decision is not to purchase a genuine article of jewelry, fully charging any secured funds if the replica jewelry items are not returned, or if the replica jewelry items are returned, releasing any secured funds less shipping charges.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIGS. 1 and 2 are flow diagrams that illustrate the manner in which the method according to the invention is carried out.

### DESCRIPTION OF THE PREFERRED EMBODIMENT AND BEST MODE

The invention described below is based on the fact that it is now possible to inexpensively replicate expensive, fine jewelry in a manner that provides a prospective purchaser the ability to examine a realistic copy of the fine jewelry item, including its appearance and weight. This requires that the metal parts of the jewelry item be made of inexpensive materials referred to as “base metals”, such as silver, pewter, nickel, brass, or alloys of these or other similar materials. In many cases, these base metals may be plated with a very thin layer of gold or other precious metal to provide the appearance of a fine jewelry item.

Relatively recent advances in the creation of artificial gemstones having the appearance of real gemstones permits the replica to provide the prospective buyer with the ability to approximate the experience of examining the real fine jewelry item. The artificial gemstone most often used instead of genuine gemstones is cubic zirconia (“CZ”). Cubic zirconia (CZ) is the cubic crystalline form of zirconium dioxide (ZrO2). The synthesized material is hard, optically flawless and usually colorless, but may be made in a variety of different colors. It should not be confused with zircon, which is a zirconium silicate (ZrSiO4). It is sometimes erroneously called “cubic zirconium.”

Because of its low cost, durability, and close visual likeness to diamond, synthetic cubic zirconia has remained the most gemologically and economically important competitor for diamonds since commercial production began in 1976. Its main competitor as a synthetic gemstone is the more recently cultivated material, synthetic moissanite, a form of silicon carbide (“SiC”), which may also be used in the practice of the method according to the disclosure of this application.

Therefore, it is possible to manufacture inexpensive, highly realistic replicas of fine jewelry items. This permits a jewelry retailer to provide an approximation of a retail store shopping experience without the customer visiting a retail store by shipping the replica to the prospective purchaser for examination.

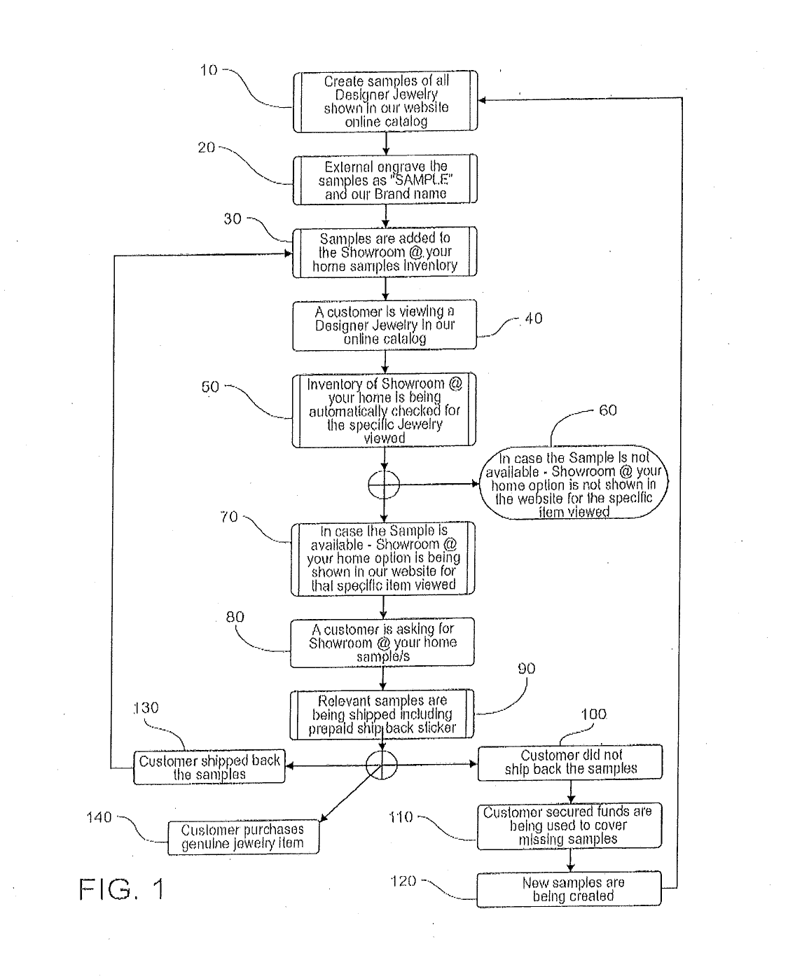

As described in FIG. 1, the method according to the invention begins by creating inexpensive, highly realistic replicas of fine jewelry items shown and offered for sale on a jewelry seller's website, at reference numeral 10. To exhibit the fact that the item is not an actual item of fine jewelry, the item is externally engraved with a term such as “sample”, “replica” or some other term, and the name of the seller, at 20. The samples are added to an inventory of samples that can be made available to online purchasers, 30. Alternatively, these samples may be included in a catalog that is mailed or emailed to a prospective customer, who can the complete the transaction in one of several ways, on-line, by telephone, or the like.

A customer views the genuine jewelry items online, 40, and the inventory of samples is automatically checked to determine whether a replica is available for the genuine items viewed, 50. If a sample of the viewed item is not in inventory, the item is not indicated as having a sample available for shipping, 60.

If a sample is available, the website indicates that the sample can be shipped to the online shopper for examination, 70. If the shopper indicates that a sample is desired, 80, the selected samples are shipped to the shopper with a prepaid ship back sticker, 90. Ordinarily, sufficient funds are secured by credit card to cover the cost of the samples if they are not returned.

As noted above, the samples are prominently engraved with the term “sample” or some other indication that is intended to deter the shopper from simply retaining the sample instead of purchasing the genuine jewelry item. If the customer does not return the sample, 100, the secured funds are debited from the shopper's account to cover the cost of the unreturned samples, 110. Samples are continually created, 120, in a sufficient quantity and variety to maintain the necessary sample inventory, 10. Whether or not the shopper decides to purchase a genuine jewelry item, the sample is intended to be returned, 130, and the funds that secured the sample shipment are released. If the shopper decides to purchase the genuine jewelry item, the selection is made online and paid for by credit card, 140. Of course, the purchase transaction can also be made by telephone or by a personal visit to the retail store.

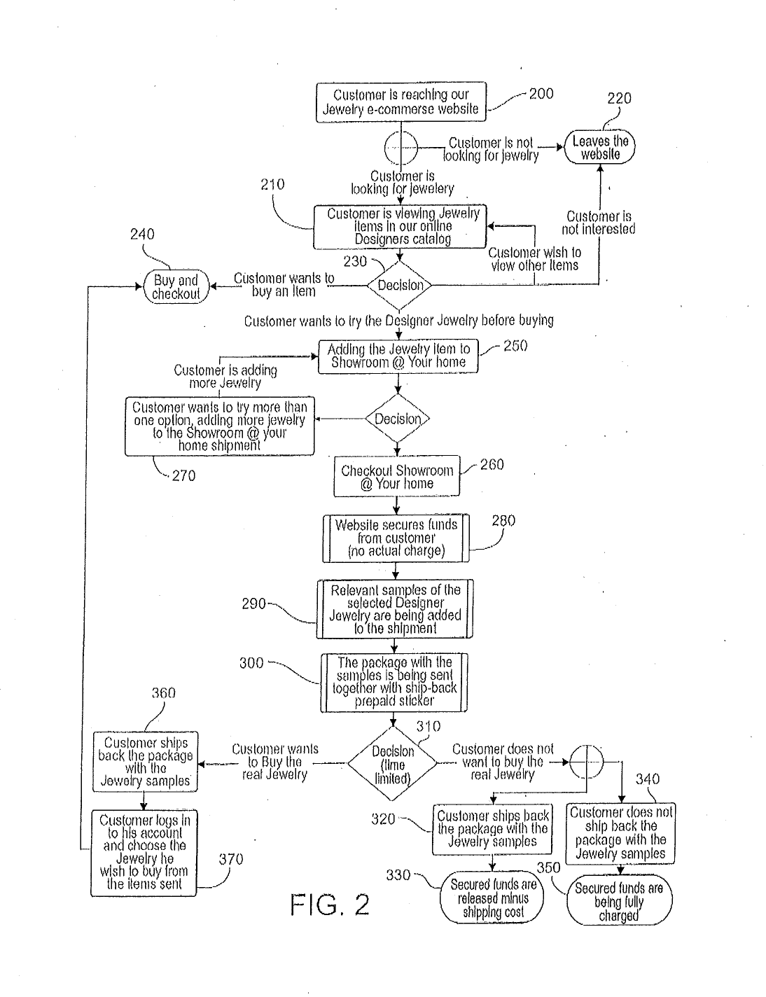

The method according to the invention is explained in more detail in FIG. 2. A prospective customer accesses, 200, and views the seller's e-commerce website, 210, via the internet. The customer either decides not to make a purchase, 220, to make a purchase outright, 230, to acquire a sample of a jewelry item the customer is considering for a purchase, 240. The customer may sample a replica of the jewelry item before purchasing it by selecting the item to sample and following the instructions to have the item shipped, 250. The customer may proceed to checkout, 260, or indicate the desire to have additional samples shipped for examination, 270. When the desired sample selections have been made, 250, the customer proceeds to the checkout area of the website, where shipping information is entered, and a credit card is used to secure funds from the customer 280. The samples are added to the shipment and shipped to the customer along with a prepaid label for use in shipping the samples back to the retailer, 290, 300. The terms of the sample shipment includes a limited time to make a purchase decision, 310.

If after examining the samples the customer decides not to make a purchase of the genuine jewelry items, the terms of the transaction require that the samples be returned by using the shipping label furnished with the shipment, 320. Upon receipt, the retailer releases the secured funds, 330. If the samples are not returned, 340, the secured funds are charged to the customer's account, 350.

If the customer decides to purchase the genuine jewelry item, 310, the customer ships the samples back to the retailer, 360, the logs into the appropriate account, selects 370 and pays by credit card for the genuine jewelry item, 240.

The method is carried out using conventional computers, internet hardware and communications equipment, together with the availability of the necessary genuine and replica jewelry items.

A method of providing a home shopping experience that includes characteristics that are usually only available when shopping in a retail store environment is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

1. An electronic method of providing a home shopping experience to a prospective purchaser of jewelry for selecting and obtaining an inexpensive replica jewelry item for determination of whether to purchase a corresponding genuine jewelry item, the method comprising:
(a) displaying, by a website hosted on a host computer, a genuine jewelry item and providing a prospective customer visiting the website an option of selecting the genuine jewelry item from the website to replicate as the inexpensive replica jewelry item;
(b) replicating, as instructed by the host computer, the genuine jewelry item in the form of the replica jewelry item and permanently marking the replica jewelry item, as instructed by the host computer, with identifying markings indicating the identity of a prospective seller of the replica jewelry item and that the replica jewelry item is replica jewelry such that each marking is visible while wearing the replica jewelry item;
(c) indicating in a selected publication, by the website, that the replica jewelry item is available for shipment to a customer address for examination by a prospective seller of genuine jewelry items;
(d) upon selection by the customer of the replica jewelry item in the selected publication of the prospective seller and communication of the selection to the prospective seller, obtaining a deposit, by the host computer, from the customer and shipping the selected replica jewelry item to the address specified by the customer; and
(e) upon a customer decision to purchase the genuine jewelry item after inspecting the replica jewelry item, shipping the genuine jewelry item to the customer and charging, by the host computer, the customer for the genuine jewelry item.

2. (canceled)

3. The method according to claim 1, wherein the deposit covers the cost of the replica jewelry item if not returned by the prospective purchaser.

4. (canceled)

5. (canceled)

6. The method according to claim 1, and including the step of shipping the replica jewelry item to the prospective customer with a prepaid label for returning the replica jewelry item.

7. The method according to claim 1, and including the steps of:
(a) custom-creating a replica jewelry item of a genuine fine jewelry item at the request of a prospective customer; and
(b) maintaining an inventory of replica jewelry items to match a selection of fine jewelry items desired to be sold in accordance with the method.

8. An electronic method of providing a home shopping experience for selecting and obtaining replica jewelry items comprising:
(a) displaying, by a website hosted on a host computer, genuine jewelry items to replicate as inexpensive replica jewelry items;
(b) creating, as instructed by the host computer, the inexpensive replica jewelry items corresponding in appearance to the genuine jewelry items and permanently marking the replica jewelry items, as instructed by the host computer, with identifying markings indicating the identity of a prospective seller of the replica jewelry items and that the replica jewelry items are replica jewelry such that each marking is visible while wearing the replica jewelry items;
(c) indicating on the website that the replica jewelry items are available for shipment to a customer address for examination by a prospective seller of genuine jewelry items;
(d) upon selection of at least one replica jewelry item by the customer via the website, obtaining a deposit, by the host computer, from the customer and shipping the selected at least one replica jewelry item by the prospective seller to the address specified by the customer; and
(e) upon a customer decision to purchase the genuine jewelry item, shipping the genuine jewelry item to the customer and charging the customer a specified sale price for the genuine jewelry item.

9. The method according to claim 8, wherein the deposit covers the cost of the at least one replica jewelry item if it is not returned to the prospective seller by the prospective purchaser.

10. (canceled)

11. (canceled)

12. The method according to claim 8, and including the step of shipping the at least one replica jewelry item to the prospective customer with a prepaid label for returning the at least one replica jewelry item to the prospective seller.

13. The method according to claim 8, and including the steps of:
(a) custom-creating the at least one replica jewelry item of a genuine fine jewelry item at the request of a prospective customer; and
(b) maintaining an inventory the at least one replica jewelry item to match a selection of fine jewelry items desired to be sold in accordance with the method.

14. The method according to claim 8, and including the step of prompting the prospective purchaser to create an on-line account for processing any transactions.

15. (canceled)

16. (canceled) The method according to claim 8, wherein the host computer is a programmable general purpose computer for carrying out the functions of the website.

17. The method according to claim 16, including the steps of:
(a) programming the computer to impose a limited amount of time for a prospective customer to make a purchase decision, and if the decision is not to purchase a genuine article of jewelry;
(b) fully charging any secured funds if the at least one replica jewelry item is not returned; and
(c) if the at least one replica jewelry item is are returned, releasing any secured funds less shipping charges.
